(19) United States
(12) Patent Application Publication
(10) Pub. No.: US 2014/0253489 A1
(43) Pub. Date: Sep. 11, 2014

(54) SYSTEMS AND METHODS FOR INDICATING THAT AN INTERFACE IS BEING TOUCHED

(71) Applicant: BRYCE T. OSOINACH, Phonex, AZ (US)

(72) Inventor: BRYCE T. OSOINACH, Phonex, AZ (US)

(21) Appl. No.: 13/787,290

(22) Filed: Mar. 6, 2013

(51) Int. Cl. G06F 3/041

(52) U.S. Cl. CPC G06F 3/041
USPC 345/174

(57) ABSTRACT

Embodiments systems that include one or more interfaces, touch sensors, and output devices implement embodiments of methods for indicating that an interface is being touched. The interface includes a first conductive structure that forms at least a portion of an electrode. In an embodiment, the interface is configured to be coupled with an apparatus for conveying electrical signals or electricity. The touch sensor is coupled to the first conductive structure, and the touch sensor is configured to make a determination of whether or not a variable electrical characteristic of the electrode has a value that is consistent with the electrode being touched. The output device produces a human-perceptible indicia in response to a determination that the variable electrical characteristic has the value that is consistent with the electrode being touched. In an embodiment, the human-perceptible indicia includes an identity of an interface associated with the particular electrode.

### TECHNICAL FIELD

Embodiments relate generally to touch sensors, machine-to-machine interfaces, and human-to-machine interfaces.

### BACKGROUND

A typical consumer or industrial device may include numerous human-to-machine and/or machine-to-machine interfaces that facilitate interaction between the device and humans or other electronic devices. For example, a conventional television set may include one or more High Definition Multimedia Interfaces (HDMI), Universal Serial Bus (USB) ports, audio/video cable interfaces, and Digital Visual Interface (DVI) connectors, along with a number of buttons that enable a user to change a channel, a volume setting, an input, and so on. For an un-savvy user, interacting with such a device and/or connecting the device with other components may be a confusing and frustrating experience. In addition, with the ever-increasing trends toward intuitive user interfaces and simple device setup and control procedures, improved human-to-machine and machine-to-machine interfaces are desired.

### BRIEF DESCRIPTION OF THE DRAWINGS

FIG. 1 illustrates a front view of an example of a device that includes one or more electrode-including interfaces, according to an example embodiment;

FIG. 2 illustrates a back view of another example of a device that includes one or more electrode-including interfaces, according to another example embodiment;

FIG. 3 illustrates a front view of the device of FIG. 2;

FIG. 4 illustrates an electrode-including interface that includes an electrode that surrounds other portions of the interface, according to an example embodiment;

FIG. 5 is a simplified, block diagram of a system with multiple electrode-including interfaces and the capability for producing a human-perceptible indicia that one or more of the interfaces is being touched, according to an example embodiment; and

FIG. 6 is a flowchart of a method for sensing whether an electrode-including interface may be being touched, and producing a human-perceptible indicia of the sensed touch state, according to an example embodiment.

### DETAILED DESCRIPTION

As used herein, the term “device interface” means a human-to-machine or machine-to-machine interface of an electronic device, at least a portion of which is accessible at an exterior of the device (e.g., the interface has a portion that is exposed at an exterior of the device housing). The term “human-to-machine interface” means any structure or subsystem of a device that enables a human user to interact with the device, including providing control inputs via a finger, hand, stylus, or other apparatus, that may affect the functioning of the device. For example, but not by way of limitation, human-to-machine interfaces may include buttons, switches, dials, and other components of a device that may be physically manipulated by a human user. For example, human-to-machine interfaces may be designed to enable user control of device power, volume, operational mode (e.g., sleep mode, active mode, silent mode, vibration mode), menu or cursor displays, and device actions (e.g., take photograph, begin/stop recording audio and/or video, activate or deactivate an application, provide an input to executing software), among other things.

The term “machine-to-machine” interface means any structure or subsystem of a device that enables the device to communicate (transmit and/or receive data or other signals) with another device, electronic component, computer, and/or network. The term “machine-to-machine” interface also means any structure or subsystem of a device that enables the device to connect with a power source (e.g., a power grid or battery), a voltage reference, or a ground reference. For example, but not by way of limitation, machine-to-machine interfaces may include portions of sub-systems that are integrated as part of a device, such as various connectors (e.g., coaxial cable connectors, shielded cable connectors, High Definition Multimedia Interface (HDMI) cable connectors, audio/video cable connectors, Digital Visual Interface (DVI) cable connectors, headphone connectors, microphone connectors, Ethernet connectors, power cord connectors), ports (e.g., Universal Serial Bus (USB) ports, serial ports, parallel ports, peripheral ports), card slots, and other types of interfaces (e.g., infrared receivers, optical interfaces, and so on). According to various embodiments, a machine-to-machine interface is configured to be coupled with an apparatus for communicating or electrical signals (e.g., signals that convey information, analog or digital signals, clock signals, control signals) or electricity (e.g., current and/or voltage from a power source (e.g., a power grid or battery), a voltage reference, or a ground reference). For example, but not by way of limitation, machine-to-machine interfaces may be configured to be coupled with a cable or cord (e.g., a coaxial cable, a shielded cable, an HDMI cable, an audio/video cable, a DVI cable, a USB cable, a headphone cord, a microphone cord, an Ethernet cable, a power cord), a data storage device (e.g., a USB data storage device, a data card), and other types of apparatus.

As will be described in more detail below, embodiments described herein include systems and methods for a device to determine that an electrode associated with a particular device interface is likely to be being touched (e.g., by a human user), and to produce a human-perceptible indication in response to the determination. In the description below, reference may be made to “determining whether an electrode associated with an interface is being touched,” or similar actions. It is to be understood that such references should be interpreted to mean that a determination is being made (e.g., by a device) whether the electrical characteristics of the electrode are consistent with characteristics that would be present when the electrode is being touched by a human user. In some cases, characteristics consistent with an electrode being touched by a human user may be present in the absence of a human touch (e.g., when the interface is being touched by something else, electrical or magnetic interference is present, and so on). Accordingly, the actual presence of human touch may not be required for the various embodiments to function. Any reference to an electrode being touched should not be interpreted to mean that human touch is essential for the embodiments to be implemented.

In addition, the electrical characteristics of some configurations of electrodes may be affected when a portion of the electrode is “touched” through an insulator covering the actual conductive structure that forms the electrode. Accordingly, use of the term “touch” herein means both a direct touch and proximate contact with an electrode through an insulator. Essentially, any action that produces an electrical signature that is characteristic of an electrode or an insulator covering the electrode being touched is considered to fall within the definition of “touch,” as that term is used herein.

According to an embodiment, a system (e.g., a device) includes one or more touch-sensitive device interfaces, one or more touch sensors coupled to the device interfaces, and one or more output devices. Each touch-sensitive device interface includes a conductive structure suitable to function as an electrode, and therefore such interfaces alternatively may be referred to as “electrode-including interfaces,” herein. A touch sensor is coupled to the conductive structure of each interface, and the touch sensor is configured to make a determination of whether or not a variable electrical characteristic of the interface is consistent with the interface being touched (e.g., by a human user). When the variable electrical characteristic is consistent with the interface being touched, the touch sensor may produce a signal indicating that the electrode associated with the interface is in a “touch state” (i.e., a state of being touched). The touch state signal may then be processed (e.g., by a processing system of the device), and an output device may be controlled to produce a human-perceptible indicia in response to the touch state signal. Various types of touch sensors may be implemented in a system.

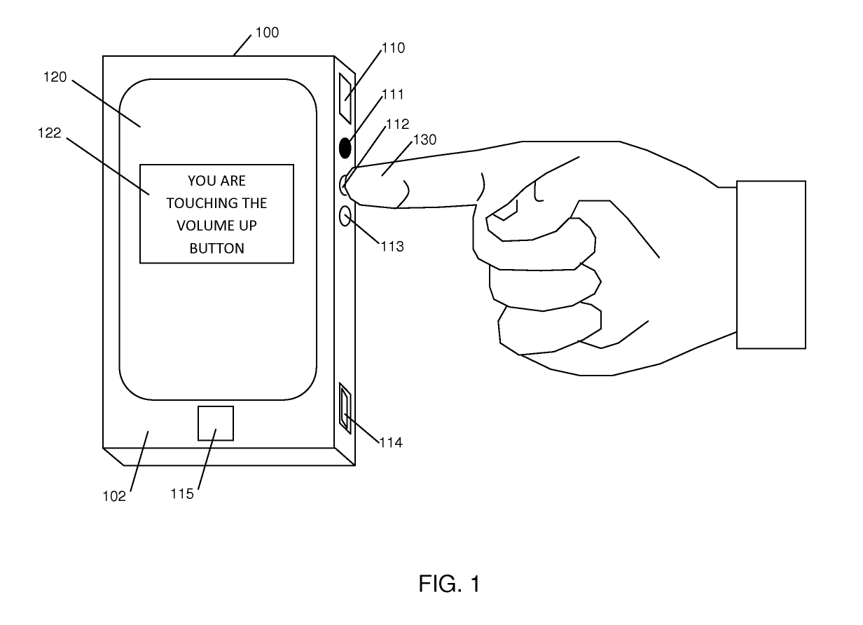

FIG. 1 illustrates a front view of an example of a device 100 that includes one or more electrode-including interfaces 110, 111, 112, 113, 114, 115 exposed at an exterior of the device housing 102, according to an example embodiment. In addition, although not shown in the illustrated external view of device 100, device 100 also includes one or more touch sensors coupled to the interfaces 110-115, and a processing system that processes signals produced by the touch sensor(s). Based on signals received from the touch sensors, the processing system may cause an output device (e.g., display 120) to produce an indication (e.g., indication 122) that one or more of the interfaces 110-115 is being touched.

In the illustrated embodiment, device 100 includes a power button 110, a headphone connector (jack) 111, a volume up button 112, a volume down button 113, a mode switch 114, and a display power button 115. Each of the interfaces 110-115 is an “electrode-including” interface, in that each interface 110-115 includes one or more conductive structures that may function as an electrode. In various embodiments, a conductive structure of an electrode-including interface may be fully contained within the interface (e.g., the conductive structure may be included within or form all or a portion of a button, switch, dial, or other component), or may be physically and electrically coupled to the interface (e.g., the conductive structure may be included within a cable that is connected to and forms a portion of the interface), or may be proximate a portion of the interface (e.g., the conductive structure may surround or be located adjacent to a button, switch, dial, connector, slot, and so on). According to an embodiment, for a conductive structure to be considered “proximate” a portion of an interface, the conductive structure is located within a distance from the portion of the interface of less than about the width of a normal fingertip, so that, if a human user were to touch the portion of the interface with his or her finger, the user likely also would touch the conductive structure that is proximate that portion of the interface.

For example, with his or her fingertip 130, a human user may touch the volume up button 112 of device 100. According to an embodiment, the volume up button 112 may include a conductive structure suitable for use as an electrode, and a touch sensor within device 100 and coupled to the conductive structure may sense a variable electrical characteristic of the conductive structure (e.g., capacitance, inductance, resistance, magnetic field, and so on). When the sensed electrical characteristic is characteristic of a touch, the sensor may send a signal indicating a touch state to a processing system of the device 100. The processing system may then cause the display 120 to produce an indication that the volume up button 112 is being touched. For example, as illustrated in FIG. 1, a popup window 122 is displayed on display 120, which states “YOU ARE TOUCHING THE VOLUME UP BUTTON.” As depicted in FIG. 1, the indicator includes an identity of the interface being touched (i.e., “volume up button” is included in the indicator). Accordingly, the user may be notified of what he or she is touching without actually looking at the interface or knowing its function with certainty. According to an embodiment, it is not necessary for the user to activate the interface (e.g., depress the volume up button 112) for the device 100 to produce the touch indication. Instead, the indication may be produced when the user merely touches the volume up button 112. According to an embodiment, analogous indications may be produced when the user touches other ones of the electrode-including interfaces 110, 111, 113-115, although those indications would indicate the identities of their respective interfaces, rather than the identity of the “volume up button.”

In other embodiments, the device 100 may provide a different type of indication that the user is touching an interface. For example, the device 100 may cause the display 120 to display a graphical depiction of the interface being touched, with or without explanatory text. Alternatively, for example, but not by way of limitation, the device 100 may produce an audible indication or a vibratory indication that an interface is being touched. In the case of an audible indication, for example, the device 100 may verbally output the indication (e.g., the processing system may control a speaker to say “you are touching the volume up button”). Alternatively, the device 100 may output an audible tone or other signal. In still other embodiments, the device 100 may illuminate a light (e.g., a light emitting diode) associated with the interface, or may produce some other indication that an interface is being touched. Any of the various indications may or may not include information identifying which particular interface is being touched.

The device 100 of FIG. 1 may be, for example, a cellular telephone. In alternate embodiments, one or more electrode-including interfaces may be included in other types of portable or non-portable electronic devices, including but not limited television sets, set-top boxes, audio-visual equipment (e.g., DVD players, amplifiers, signal selectors, and so on), radios, desktop and laptop computers, tablet computing devices, portable entertainment devices (e.g., music and video players), personal digital assistants (PDAs), electronic gaming devices, electronic game consoles, remote control devices, control consoles, appliances, and so on. Essentially, electrode-including interfaces and their associated touch sensors may be included in any electronic device that also includes suitable processing capabilities and one or more devices suited to produce a human-perceptible indicia.

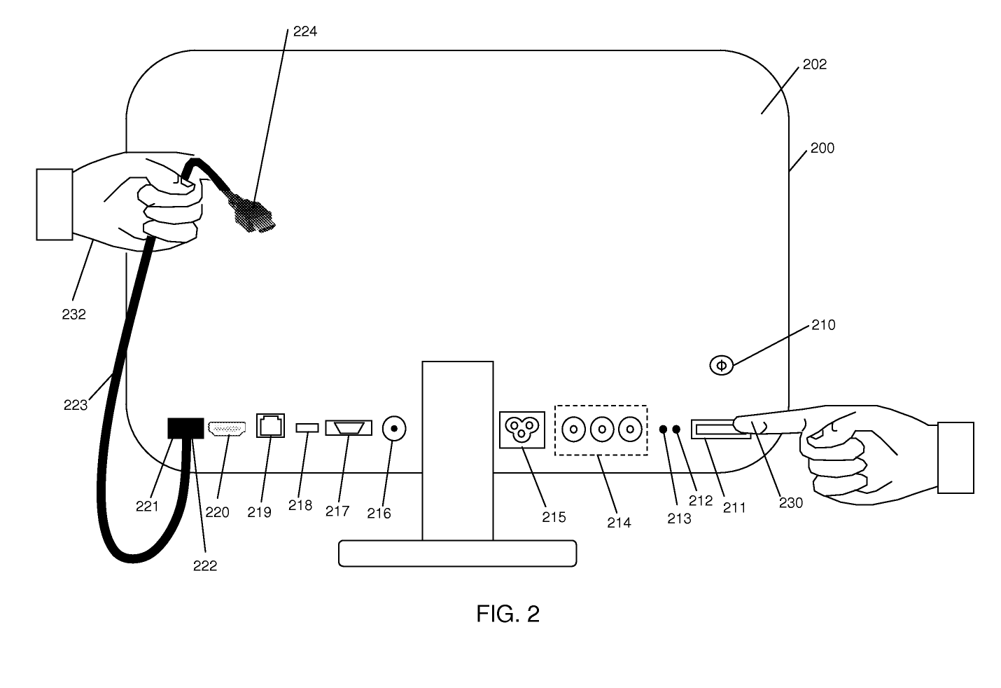

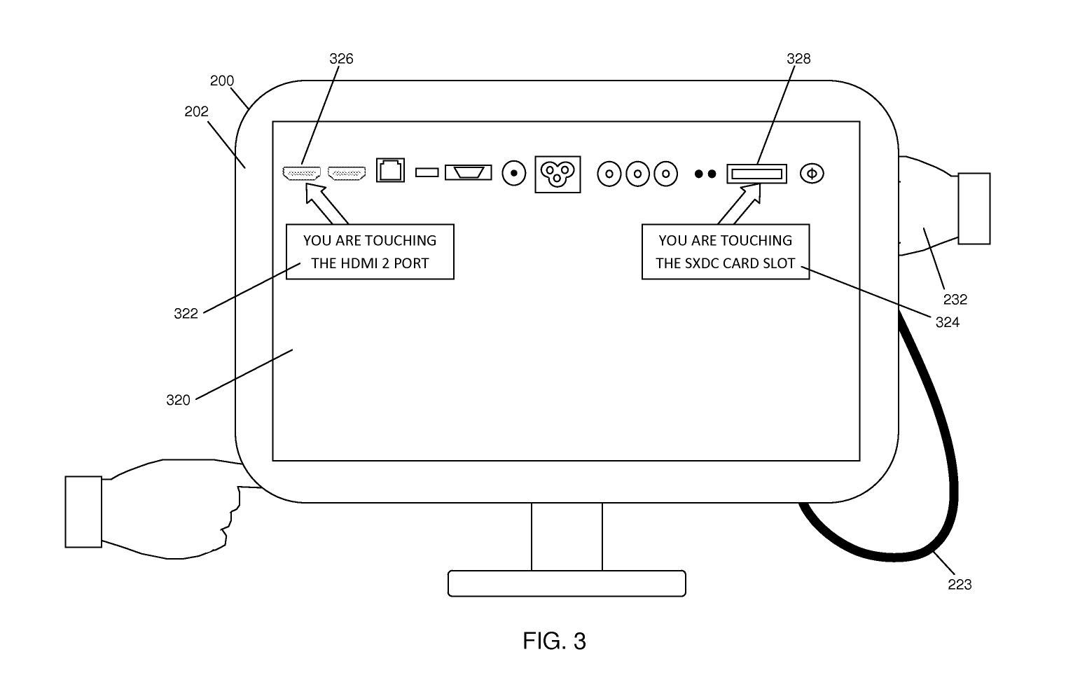

FIG. 2 illustrates a back view of another example of a device 200 that includes one or more electrode-including interfaces 210, 211, 212, 213, 214, 215, 216, 217, 218, 219, 220, 221 exposed at an exterior of the device housing 202, according to another example embodiment, and FIG. 3 illustrates a front view of the device 200 of FIG. 2. In addition, although not shown in the illustrated external view of device 200, device 200 also includes one or more touch sensors coupled to the interfaces 210-221, and a processing system that processes signals produced by the touch sensor(s). Based on signals received from the touch sensors, the processing system may cause an output device (e.g., display 320) to produce an indication (e.g., indications 322, 324) that one or more of the interfaces 210-221 is being touched.

For example, device 200 may be a desktop computer or a television set, although as discussed previously, embodiments of the inventive subject matter can be implemented in other types of devices, as well. The electrode-including interfaces 210-221 of device 200 include a power button 210, a card slot 211, a headphone jack 212, a microphone jack 213, audio/video cable connectors 214, a power connector 215, a coaxial cable connector 216, video/audio cable connectors 217, a universal serial bus (USB) port 218, an Ethernet port 219, and two high definition multimedia interface (HDMI) ports 220, 221. In other embodiments, a device may include multiple ones of any of these types of interfaces, and/or one or more other types of electrode-including interfaces (e.g., other types of input/output ports, receiver ports (e.g., infrared receivers), and so on).

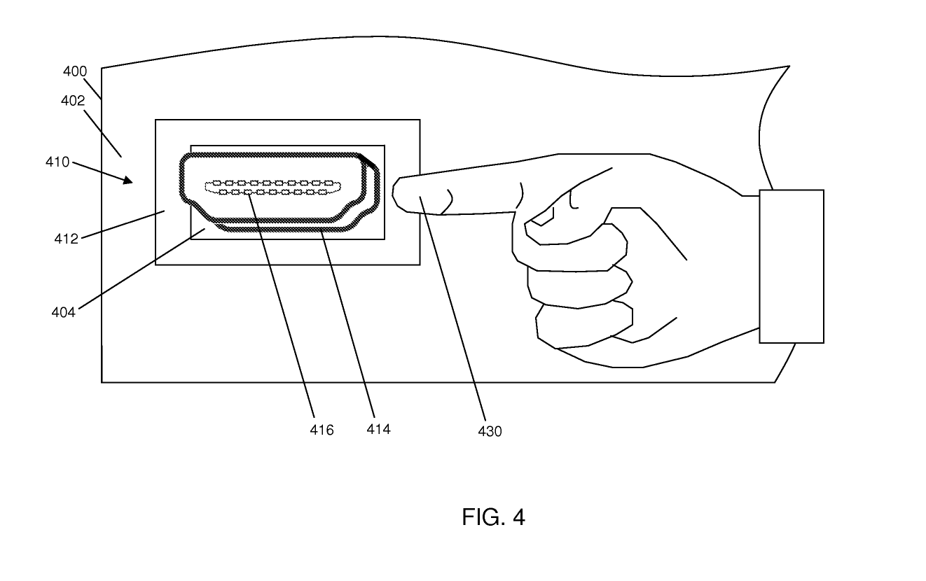

Each of the electrode-including interfaces 210-223 includes one or more conductive structures that may function as an electrode, or as a portion of an electrode. In various embodiments, a conductive structure of an electrode-including interface may be fully contained within the interface (e.g., the conductive structure may be included within or form all or a portion of a button, slot, jack, I/O port, power cord connector, or other interface), or the conductive structure may be proximate a portion of the interface (e.g., the conductive structure may surround or be located adjacent to a button, slot, jack, I/O port, power cord connector, or other interface). In either case, the interface is said to “include” the conductive structure and the electrode. Alternatively, an electrode may include multiple physically and electrically coupled conductive structures (referred to below as a “composite conductive structure”), where one conductive structure is included in the interface, and one or more additional conductive “extension structures” are physically and electrically coupled to the conductive structure that is included within the interface. In such embodiments, the “electrode” may be considered to include the conductive structure included within the interface, along with the extension structures. For example, a cable, cord, card, or other item that is coupled to an electrode-including interface 210-223 may include one or more extension structures that physically and electrically couple with a conductive structure included within the interface (e.g., when the cable, cord, card or other item is coupled to the interface). For example, HDMI port 221 may be an electrode-including interface, which includes a first conductive structure. When a connector or plug 222 at one end of an HDMI cable 223 is coupled to HDMI port 221, the conductive structure within the HDMI port 221 may be physically and electrically coupled with conductive extension structures within the plug 222, cable 223, and opposite plug 224. Together, the conductive structure within the HDMI port 221 and the extension structures may be considered to comprise an “electrode,” the electrical characteristics of which may be sensed by a touch sensor of device 200. As a more specific example, HDMI port 221 may include a conductive shield structure (e.g., shield structure 414, FIG. 4) that forms one portion of an electrode (e.g., a conductive structure included in HDMI port 221), and when an HDMI cable 223 is plugged into the HDMI port 221, electrically coupled shield components of the plugs 222, 224 and cable 223 may form additional portions of the electrode (e.g., conductive extension structures). When any portion of the composite conductive structure is touched (including being touched through an insulator covering one of the conductive structures, such as an insulator over conductive portions of the cable 223), the electrical characteristics of the composite conductive structure (or the electrode) may be affected. For example, when the HDMI cable 223 is grasped by a user's hand 232, the electrical characteristics of an electrode formed from the coupled conductive structures of the plugs 222, 224, cable 223, and connector 221 may be affected. Although an example of a composite conductive structure is described to include shield structures, above, a composite conductive structure alternatively could include a signal connector, a power connector, or a ground connector of an interface, along with a corresponding signal line, power line, or ground line of an apparatus that is coupled with the interface. For example, a first portion of a composite conductive structure may include a pin or pin receptacle of an interface (referred to as an interface pin connector), and a second portion of a composite conductive structure may include a conductive line within a cable or cord that connects with the interface pin connector. Similarly, the electrical characteristics of other ones of the electrode-including interfaces 210-220 also may be affected by a touch, either to the interface itself or to a cable, card or other apparatus that is coupled with the interface. For example, with a fingertip 230, a human user may touch electrode-including slot 230 of device 200 (or any other electrode-including interface), and the touch may affect the electrical characteristics of a conductive structure that functions as an electrode of the slot 230.

One or more touch sensors within device 200 are coupled to the conductive structures of electrode-including interfaces 210-221, according to an embodiment. The sensor(s) may sense variable electrical characteristics of the conductive structures (e.g., capacitance, inductance, resistance, magnetic field, and so on). When the sensed electrical characteristics are characteristic of a touch, a sensor may send a signal indicating a touch state to a processing system of the device 200. The processing system may then cause the display 320 (FIG. 3) to produce an indication that the interface 210-221 (or a cable or cord connected to the interface) is being touched. For example, in the example depicted in FIGS. 2 and 3, with both slot 211 and the HDMI cable 223 being touched, multiple indicators in the form of popup windows 322, 324 are displayed on display 320, which state that “YOU ARE TOUCHING THE HDMI 2 PORT” and “YOU ARE TOUCHING THE SXDC CARD SLOT.” As depicted in FIG. 3, the indicators include identities of the interfaces being touched (i.e., “HDMI 2 PORT” and “SXDC CARD SLOT” are included in the indicators). In addition, the identities of the interfaces are graphically depicted by iconic representations 326, 328 of the slot 211 and HDMI port 221. Accordingly, as with the system 100 of FIG. 1, the user may be notified of what he or she is touching without actually looking at the interface or knowing its type. According to an embodiment, analogous indications may be produced when the user touches other ones of the electrode-including interfaces 210, 212-220, although those indications would indicate the identities of their respective interfaces.

In other embodiments, the device 200 may provide a different type of indication that the user is touching an interface. For example, the device 200 may cause an icon to appear, change color or flash on display 230. Alternatively, the device 200 may produce an audible indication that an interface is being touched. In the case of an audible indication, for example, the device 200 may verbally output the indication (e.g., the processing system may control an audio output device to say “you are touching the HDMI 2 port” or “you are touching the SXDC card slot”). Alternatively, the device 200 may output an audible tone or other signal. In still other embodiments, the device 200 may illuminate a light (e.g., a light emitting diode) associated with the interface, or may produce some other indication that an interface is being touched. In still other embodiments, the device 200 may produce a vibration indicating that an interface is being touched. Any of the various indications may or may not include information identifying which particular interface is being touched.

As discussed previously, an electrode-including interface may include a conductive structure that is proximate a portion of the interface (e.g., surrounding or located adjacent to a portion of the interface), that is fully contained within the interface, or that includes extension structures that are physically and electrically coupled to the interface. As an example of the former type of electrode-including interface, FIG. 4 illustrates an electrode-including interface 410, which includes an electrode 412 surrounding other portions of the interface 410, according to an example embodiment. The electrode-including interface 410 is exposed at an exterior of a housing 402 of a device 400 (only a portion of which is shown in FIG. 4) with which the interface 410 is integrated. In the illustrated example, interface 410 is an HDMI port, which includes shield structure 414, a plurality of pin connectors 416, and electrode 412, which surrounds the shield structure 414, but is electrically isolated from the shield structure 414 by a portion 404 of housing 402.

A touch sensor within device 400 may be coupled to electrode 410, and the sensor may sense variable electrical characteristics of the electrode 410. When the sensed electrical characteristics are characteristic of a touch (e.g., a touch by fingertip 430), the sensor may send a signal indicating a touch state to a processing system of the device 400. The processing system may then cause a human-perceptible indicia of the touch to be produced, as discussed previously.

Although the example of FIG. 4 depicts a particular type of electrode-including interface (specifically an HDMI port), where the electrode includes a conductive structure surrounding the interface, it is to be understood that the inventive concepts could be implemented in a multitude of different types of interfaces, including but not limited to those discussed previously. In addition, although electrode 410 is shown to surround other portions of the interface 410, an electrode 410 may not entirely surround other portions of an interface, multiple electrodes may be placed proximate to other portions of an interface, and/or the electrode may touch or be formed from other portions of the interface (e.g., shield structure 414, a pin connector 416, or other portions of interface 410).

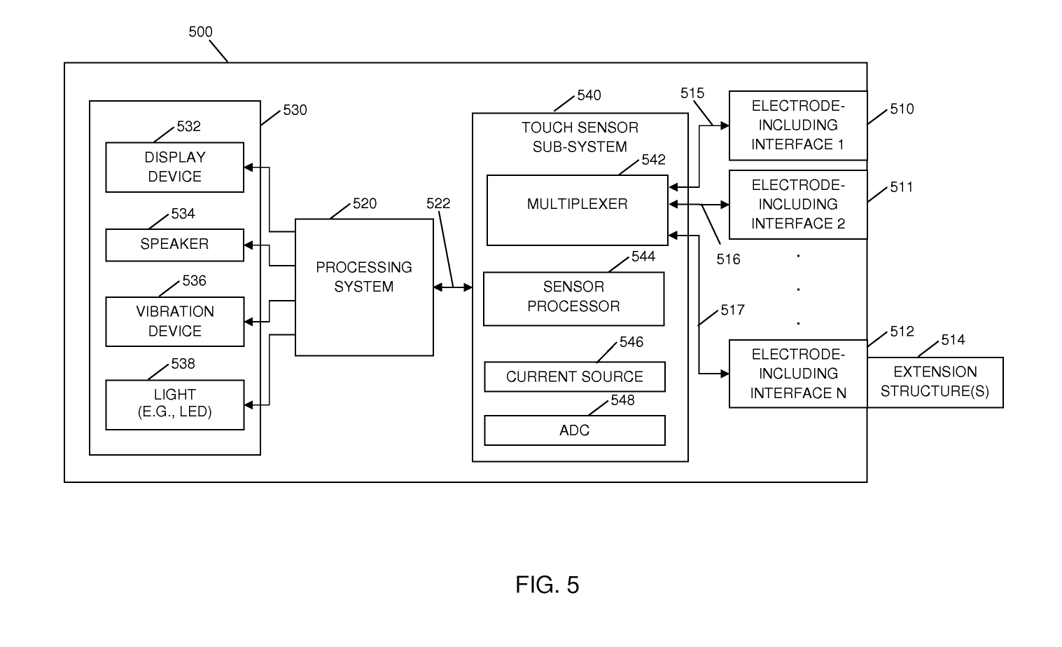

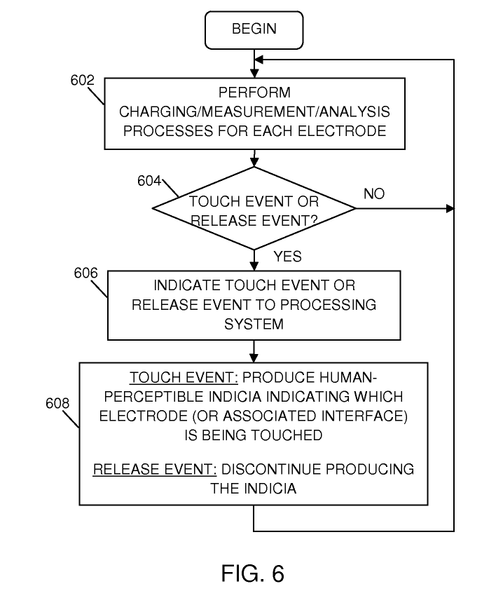

FIG. 5 is a simplified, block diagram of a portion of an electronic system 500 with multiple electrode-including interfaces 510, 511, 512 and the capability for producing a human-perceptible indicia that electrodes associated with one or more of the interfaces 510-512 is being touched, according to an example embodiment. The functionality of electronic system 500 will be explained also in conjunction with FIG. 6, which is a flowchart of a method for sensing whether an electrode-including interface may be being touched, and producing a human-perceptible indicia of the sensed touch state, according to an example embodiment. Essentially, according to an embodiment, when a user touches an electrode-including interface 510-512 (or an extension structure 514 connected to an electrode-including interface 512), the system 500 may determine that the electrical characteristics of the conductive structure(s) that form the electrode of the interface 510-512 are characteristic of a human touch, and the system 500 may produce a human-perceptible indicia to that effect.

The portion of the system 500 may be incorporated within a cellular telephone (e.g., device 100, FIG. 1), a television set, a set-top box, audio-visual equipment, a radio, a desktop or laptop computer (e.g., device 200, FIG. 2), a tablet computing device, a portable entertainment device, a PDA, an electronic gaming device, an electronic game console, a remote control device, a control console, an appliance, or any of various other types of electronic devices. According to an embodiment, the system 500 includes a processing system 520, one or more human-perceptible indicia devices 530, a touch sensor sub-system 540, and from one to N electrode-including interfaces 510-512, where N is an integer (e.g., an integer in a range from 1 to 20 or more).

Each of the electrode-including interfaces 510-512 includes a conductive structure suitable to function as an electrode on its own, or suitable to function as a portion of an electrode when the conductive structure is coupled with other conductive extension structures (e.g., within a cable, cord, card, or other item). The conductive structure included within each interface 510-512 may form all or a portion of the interface or may be proximate to a portion of the interface, as discussed previously. For example, as mentioned previously, electrode-including interfaces 510-512 may include any combination of buttons, switches, dials, connectors, slots, jacks, I/O ports, power cord connectors, or other interfaces, and an electrode may be formed from a conductive structure of the interface 510-512. In some cases, such as described in conjunction with FIGS. 2 and 3, a composite conductive structure associated with an electrode-including interface (e.g., interface 512) may include a conductive structure of the interface and one or more additional extension structures 514 that are physically and electrically coupled with the conductive structure of the interface (e.g., the extension structures 514 may be included within a cable, cord, card or other item that is connected to the electrode-including interface 512). In such cases, the electrode of the electrode-including interface may be considered to include both the conductive structure within the electrode-including interface and the extension structures.

A conductive structure of each of the electrode-including interfaces 510-512 is electrically coupled to touch sensor sub-system 520 through charging and measurement lines 515, 516, 517. Although each charging and measurement line 515-517 is shown to be a single line, each single line 515-517 could be replaced by a pair of lines that includes a distinct charging line and a distinct measurement line. Either way, a charging and measurement processes is performed for each electrode associated with each electrode-including interface 510-512 over the charging and measurement lines 515-517, according to various embodiments.

Referring also to FIG. 6, touch sensor sub-system 540 repeatedly performs charging, voltage measurement, and analysis processes for each of the electrodes associated with each of the electrode-including interfaces 510-512 (block 602, FIG. 6). Touch sensor sub-system 540 may be implemented using one or more integrated circuit chips and/or discreet components that are interconnected to provide the below-described functionalities. Although a particular architecture for touch sensor sub-system 540 is described below, it is to be understood that touch sensor sub-system 540 may be implemented differently, as well, in other embodiments.

In an embodiment, touch sensor sub-system 540 includes at least a multiplexer 542, a sensor processor 544, a current source 546, and an analog-to-digital converter (ADC) 548. During operation, sensor processor 544 may select a first electrode (e.g., an electrode associated with electrode-including interface 510) for monitoring by providing a select signal to multiplexer 542. The select signal indicates that multiplexer 542 should enable a connection between current source 546 and the selected electrode for purposes of charging. Sensor processor 544 may retrieve charging parameters for the selected electrode from data storage (not illustrated), and may provide a control signal to current source 546 over a control line, which indicates the charging current level. In addition, sensor processor 544 may control a clock/timer (not illustrated) to provide an enable signal to current source 546, which causes current source 546 to provide a current having the charging current level to multiplexer 542. Multiplexer 542, in turn, provides the current to electrode-including interface 510 over charging and measurement line 515. Upon expiration of the charging interval, the clock/timer may provide a disable signal to current source 546, which causes current source 546 to cease providing the current to multiplexer 542.

When provision of the current is terminated (e.g., at the end of the charging interval), the touch sensor sub-system 540 may measure the voltage of the electrode of electrode-including interface 510. For example, touch sensor sub-system 540 may perform a voltage measurement for the selected electrode by providing another control signal to multiplexer 542, which enables multiplexer 542 to access an analog voltage signal for the selected electrode over charging and measurement line 515. The select signal causes multiplexer 542 to enable a connection between the charging and measurement line 515 and ADC 548 for purposes of sensing the voltage on the electrode associated with electrode-including interface 510.

ADC 548 converts the received analog voltage signal to a digital value, which may be represented as an ADC count, according to an embodiment. In other words, ADC 548 samples the analog voltage signal in order to produce one or more digital values. ADC 548 then provides the sampled, digital value(s) to sensor processor 544. The electrode may then be discharged to zero volts during a discharge interval, and the process may be repeated one or more times in order to obtain one or more additional voltage measurements for the same selected electrode. Sensor processor 544 may then evaluate the voltage measurement(s) to determine, for example, whether a touch event has occurred or a release event has occurred (block 606, FIG. 6). Essentially, to analyze the voltage measurement(s), sensor processor 544 compares the voltage measurement(s) with a stored baseline voltage for the associated electrode. When the difference between a voltage measurement and the stored baseline voltage does not exceed a touch detection delta, the sensor processor 544 may make a determination that the electrode associated with the electrode-including interface 510 is in a “no-touch state”. Conversely, when the difference between a value and the baseline voltage exceeds the touch detection delta, the sensor processor 544 may make a determination that a touch event has occurred, and thus that the electrode is in a “touch state”. While in the touch state, the sensor processor 544 may continue to repeat the charging and measuring process until a comparison between the determined values and the baseline voltage for the individual electrode yields a difference that is less than a release detection delta. At that time, the sensor processor 544 may determine that a release event has occurred, and thus that electrode is again in the no-touch state.

Touch sensor sub-system 540 is operatively coupled with processing system 520. Processing system 520 may include a special purpose or general purpose microprocessor, a digital signal processor, an Application Specific Integrated Circuit (ASIC), or some other type of processing component. Processing system 520 and touch sensor sub-system 540 may communicate over communication interface 522. According to an embodiment, the communication interface 522 may include one or more interrupt lines and one or more communication lines. For example, communication interface 522 may include transmission means to support an I²C (Inter-Integrated Circuit) communication protocol, in an embodiment. In other embodiments, communication interface 522 may include transmission means to support an SPI (Serial Peripheral Interface) protocol, a UART (Universal Asynchronous Receiver/Transmitter) protocol, or some other type of inter-processor communication protocol.

Various types of interrupts, control signals, and data may be transferred over communication interface 522. For example, processing system 520 may provide control signals over communication interface 522, which are adapted to activate or deactivate (e.g., enable or disable) touch sensor sub-system 540. In addition, when touch sensor sub-system 540 detects a touch event or a release event (block 604, FIG. 6), touch sensor sub-system 540 may provide an indication of the touch event or the release event over communication interface 522 (block 606, FIG. 6). For example, in response to either type of event, touch sensor sub-system 540 may provide an interrupt over communication interface 522. In response to the interrupt, processing system 520 may provide a request for information regarding the interrupt (e.g., a request to read a register of touch sensor sub-system 540 that describes the triggering event for the interrupt). Touch sensor sub-system 540 may then return data which indicates, for example, an electrode or interface identity (e.g., the identity of a particular electrode-including interface 510-512) and an indicator of a touch event or a release event. Alternatively, when touch sensor sub-system 540 determines that an electrode is in a touch state, touch sensor sub-system 540 may send a signal to processing system 520 over communication interface 522. For example, the signal may include an identity of an electrode-including interface 510-512, and an indication that the electrode associated with the electrode-including interface 510-512 is in a touch state (or that a touch event has occurred).

In any event, when processing system 520 receives an indication that an electrode associated with an electrode-including interface 510-512 is being touched, processing system 520 may cause one or more of the human-perceptible indicia devices 530 to produce an indicia that the electrode associated with the electrode-including interface 510-512 is being touched (block 608, FIG. 6). For example, the human-perceptible indicia devices 530 may include any one or more of a display device 532, a speaker 534, a vibration device 536, a light 538 (e.g., an LED), and/or any other type of device that is capable of producing a human-perceptible indicia. In various embodiments, and as discussed previously, the indicia that an electrode-including interface 510-512 is being touched may include an identity of the interface being touched, and the indicia may include displayed text indicating that the interface is being touched, a displayed icon representing the interface, audible speech indicating that the interface is being touched, another audible indicator, a vibration of the device, an illumination of a light, or a combination of such indicia.

Referring again to the functioning of the touch sensor sub-system 540, the touch sensor sub-system 540 also may provide an interrupt and/or a signal to processing system 520, which indicates that the electrode of an electrode-including interface 510-512 is in a no-touch state (e.g., when the difference between a voltage measurement and the stored baseline voltage does not exceed the touch detection delta). The touch sensor sub-system 540 may provide such an interrupt or signal each time such a determination is made, for example, or the touch sensor sub-system 540 may provide the interrupt or signal when a release event has been detected (e.g., when the electrode previously was in a touch state, and a determination is then made that the difference between a voltage measurement and the stored baseline voltage does not exceed a release detection delta). When the processing system 520 receives the no-touch indication, the processing system 520 may either refrain from causing a human-perceptible indication of a touch to be produced, or the processing system 520 may cause the production of such a human-perceptible indication to be discontinued (block 608, FIG. 6).

According to an embodiment, after having performed the charging and measurement process for a particular electrode (e.g., for the electrode of electrode-including interface 510), sensor processor 544 may then select another electrode (e.g., the electrode associated with electrode-including interface 511) through a control signal to multiplexer 542, and the touch sensor sub-system 540 may repeat the charging and measurement process for the next selected electrode. This process may be performed for all remaining electrodes, thus completing a first iteration of monitoring the electrode voltages. At the end of the iteration of monitoring the electrode voltages for each individual electrode, sensor processor 544 may perform additional iterations of charging and monitoring the system's electrodes may, beginning again with the first selected electrode (e.g., the electrode associated with electrode-including interface 510).

In the above-described embodiment, touch sensor sub-system 540 essentially includes a single touch sensor system (e.g., including sensor processor 544, current source 546, and ADC 548), which can be coupled to the electrodes of multiple electrode-including interfaces 510 using multiplexer 542. In an alternate embodiment, touch sensor sub-system 540 may include multiple touch sensor systems, including a distinct touch sensor system for each electrode-including interface 510-512. In such an embodiment, multiplexer 542 may be excluded from the system. In addition, in such an embodiment, the charging and measurement processes may be performed for electrodes of multiple electrode-including interfaces 510-512 simultaneously.

An embodiment of a system includes an interface, a touch sensor, and an output device. The interface includes a first conductive structure that forms at least a portion of an electrode, and the interface is configured to be coupled with an apparatus for conveying electrical signals or electricity. The touch sensor is coupled to the first conductive structure, and the touch sensor is configured to make a determination of whether or not a variable electrical characteristic of the electrode has a value that is consistent with the electrode being touched. The output device produces a human-perceptible indicia in response to a determination that the variable electrical characteristic has the value that is consistent with the electrode being touched.

Another embodiment of a system includes a plurality of interfaces, one or more touch sensors, and an output device. Each interface of the plurality of interfaces includes a first conductive structure that forms at least a portion of an electrode. The one or more touch sensors are coupled to the conductive structures of the plurality of interfaces, and the one or more touch sensors determine whether or not a variable electrical characteristic of each electrode has a value that is consistent with the electrode being touched. The output device produces a human-perceptible indicia in response to a determination that the variable electrical characteristic of a particular electrode has a value that is consistent with the particular electrode being touched, and the human-perceptible indicia includes an identity of an interface associated with the particular electrode.

An embodiment of a method is implemented in a device that includes a touch sensor, an output device, and an interface that is configured to be coupled with an apparatus for conveying electrical signals or electricity. The method includes determining, by the touch sensor, whether a variable electrical characteristic of an electrode has a value that is consistent with the electrode being touched, where the electrode includes a first conductive structure included within the interface of the device. The method also includes producing, by the output device, a human-perceptible indicia in response to a determination that the variable electrical characteristic has the value that is consistent with the electrode being touched.

While the principles of the inventive subject matter have been described above in connection with specific systems, apparatus, and methods, it is to be clearly understood that this description is made only by way of example and not as a limitation on the scope of the inventive subject matter. The various functions or processing blocks discussed herein and illustrated in the Figures may be implemented in hardware, firmware, software or any combination thereof. Further, the phraseology or terminology employed herein is for the purpose of description and not of limitation.

The foregoing description of specific embodiments reveals the general nature of the inventive subject matter sufficiently that others can, by applying current knowledge, readily modify and/or adapt it for various applications without departing from the general concept. Therefore, such adaptations and modifications are within the meaning and range of equivalents of the disclosed embodiments. The inventive subject matter embraces all such alternatives, modifications, equivalents, and variations as fall within the spirit and broad scope of the appended claims.

What is claimed is:

1. A system comprising:
an interface that includes a first conductive structure that forms at least a portion of an electrode, wherein the interface is configured to be coupled with an apparatus for conveying electrical signals or electricity;
a touch sensor coupled to the first conductive structure, wherein the touch sensor is configured to make a determination of whether or not a variable electrical characteristic of the electrode has a value that is consistent with the electrode being touched; and
an output device, wherein the output device produces a human-perceptible indicia in response to a determination that the variable electrical characteristic has the value that is consistent with the electrode being touched.

2. The system of claim 1, wherein the first conductive structure is selected from a shield structure, a signal connector, a power connector, and a ground connector.

3. The system of claim 1, wherein the interface is configured to be connected with a cable or cord, and the electrode comprises the first conductive structure and a conductive extension structure that forms a portion of the cable or cord.

4. The system of claim 3, wherein the first conductive structure includes a shield structure of the interface, and the conductive extension structure includes a shield component of the cable.

5. The system of claim 3, wherein the first conductive structure includes a pin connector of the interface, and the conductive extension structure includes a conductor of the cable that connects with the pin connector.

6. The system of claim 1, wherein the first conductive structure is located in proximity to other portions of the interface.

7. The system of claim 6, wherein the first conductive structure at least partially surrounds the other portions of the interface.

8. The system of claim 1, wherein the interface is selected from a coaxial cable connector, a shielded cable connector, a High Definition Multimedia Interface (HDMI) cable connector, a Universal Serial Bus (USB) port, an audio/video cable connector, a Digital Visual Interface (DVI) cable connector, a serial port, a parallel port, a peripheral port, a headphone connector, a microphone connector, an Ethernet connector, a power cord connector, and a card slot.

9. The system of claim 8, wherein the electrode further includes a conductive extension structure that forms a portion of a coaxial cable, a shielded cable, an HDMI cable, a USB cable, a USB data storage device, an audio/video cable, a DVI cable, an Ethernet cable, a headphone cord, a microphone cord, a power cord, and a data card.

10. The system of claim 1, wherein the output device comprises a display device, and wherein the human-perceptible indicia includes a displayed indicia of an identity of the interface.

11. The system of claim 10, wherein the human-perceptible indicia includes a displayed icon indicating the identity of the interface.

12. The system of claim 10, wherein the human-perceptible indicia includes displayed text indicating the identity of the interface.

13. The system of claim 1, wherein the output device is selected from a display device, a speaker, a vibration device, and a light.

14. A system comprising:
a plurality of interfaces, wherein each interface of the plurality of interfaces includes a first conductive structure that forms at least a portion of an electrode;
one or more touch sensors coupled to the conductive structures of the plurality of interfaces, wherein the one or more touch sensors determine whether or not a variable electrical characteristic of each electrode has a value that is consistent with the electrode being touched; and
an output device, wherein the output device produces a human-perceptible indicia in response to a determination that the variable electrical characteristic of a particular electrode has a value that is consistent with the particular electrode being touched, wherein the human-perceptible indicia includes an identity of an interface associated with the particular electrode.

15. The system of claim 14, wherein the interface is a machine-to-machine interface configured to be coupled with an apparatus for conveying electrical signals or electricity.

16. The system of claim 15, wherein the interface is selected from a coaxial cable connector, a shielded cable connector, a High Definition Multimedia Interface (HDMI) cable connector, a Universal Serial Bus (USB) port, an audio/video cable connector, a Digital Visual Interface (DVI) cable connector, a serial port, a parallel port, a peripheral port, a headphone connector, a microphone connector, an Ethernet connector, a power cord connector, and a card slot.

17. The system of claim 14, wherein the interface is a human-to-machine interface selected from a button, a switch, a dial, and another component that may be physically manipulated by a human user.

18. A method implemented in a device that includes a touch sensor, an output device, and an interface that is configured to be coupled with an apparatus for conveying electrical signals or electricity, the method comprising the steps of:
determining, by the touch sensor, whether a variable electrical characteristic of an electrode has a value that is consistent with the electrode being touched, wherein the electrode includes a first conductive structure included within the interface of the device; and
producing, by the output device, a human-perceptible indicia in response to a determination that the variable electrical characteristic has the value that is consistent with the electrode being touched.

19. The method of claim 18, wherein determining whether the variable electrical characteristic of the electrode has the value that is consistent with the electrode being touched comprises:
performing a charging process, by the touch sensor, to charge the electrode;
performing a measurement process, by the touch sensor, to measure a voltage of the electrode; and
analyzing the voltage to determine whether the voltage has a value that is consistent with the electrode being touched.

20. The method of claim 18, further comprising:
providing information, by the touch sensor to a processing system of the device, when the determination is made that the variable electrical characteristic has the value that is consistent with the electrode being touched, wherein the information indicates an identity of the interface; and
the processing system causing the human-perceptible indicia to be produced by the output device, wherein
the human-perceptible indicia includes an indicia selected from displayed text indicating that the interface is being touched, a displayed icon representing the interface, audible speech indicating that the interface is being touched, another audible indicator, a vibration of the device, and an illumination of a light.
